(19) United States
(12) Patent Application Publication
(10) Pub. No.: US 2008/0250106 A1
(43) Pub. Date: Oct. 9, 2008

(54) Use of Acceptance Methods for Accepting Email and Messages

(76) Inventors: George Leslie Rugg, Danville, CA (US); Kenneth Thomas Fallon, Las Vegas, NV (US)

Correspondence Address: George L. Rugg, 72 Emerald Drive, Danville, CA, 94526, US

(21) Appl. No.: 11/695,609

(22) Filed: Apr. 3, 2007

(51) Int. Cl. G06F 15/16

(52) U.S. Cl. 709/206

(57) ABSTRACT

An email and message management system invention that rejects all emails and messages unless the messages pass acceptance filter criteria. Without any filtering this invention will refuse to accept all incoming email and messages, whereas current systems accept all email messages without filtering aids. The invention uses several acceptance filtering methods including: a list of acceptable origin message addresses, a list of acceptable origin domain addresses, an algorithm criterion that allows messages based on wildcard type comparisons, a rules method that provides a means to use logic directives, and a method that allows the use of Pass Key Codes to automatically accept messages and to enhance message security. The invention includes an administrative function to set up and maintain the acceptance criteria, provide notification to users of rejected emails, message traffic monitoring for system quality control, and control of a network of the inventions.

### SPECIFICATION BACKGROUND—FIELD OF INVENTION AND FIGURE DESCRIPTION

The Use of Acceptance Methods for Accepting Email and Messages is an invention that rejects all email and message traffic in its default configuration and in order to receive emails and messages, the user must specify filter criteria to accept messages. This method of managing email works in the exact opposite manner of existing email systems. Current email and message systems' default mode is to first accept all incoming messages and if enabled, have filtering systems designed to exclude, or reject undesirable messages. If the filtering system is not enabled in this invention, no email or messages will be accepted by the system. For the purposes of this document the inventors define the invention as an Acceptance Method for Accepting Email and Messages since messages must pass acceptance filters. Conversely, existing systems will be referred to as rejection or exclusion methods. The fundamental problem with the rejection methods of email filtering is that there are virtually an unlimited number of domain names and email sources that can send email messages. And while users can block specific domain names and email addresses, it would be nearly impossible to block them all using exclusion filtering. This problem is further exacerbated by the fact that the internet business climate is booming with no letup in sight. There are hundreds, probably thousands, of internet-based businesses that rely on valid email addresses for low cost lead generation and email lists are bought and sold on the internet to any company with the money to buy them. It has proven impossible to exclude undesirable emails by using rejection filters for specific domains and emails addresses. New ones keep appearing and there is just no way to effectively control who they send email to. The attempted solution to this realization was an advancement of exclusion filtering technology designed to search for specific content, such as explicit language or drug names, but spammers and advertisers proved that there are a many, relatively easy, ways to deceive even the most sophisticated exclusion filtering mechanisms. We all witnessed these deceptions with simple misspellings, like -v-i-a-g-r-a-, which effectively bypassed the very filters designed to detect them. One can spend hours devising schemes to exclude undesirable messages, only to find that the some undesirable email still gets through, or, desirable email is inadvertently filtered out. Exclusion email filter management has become such a demanding process that many people have just stopped trying to keep the filters up to date. We have come to accept that our email addresses are not private and our inboxes have become just like the mailboxes in front of our houses; anybody can put anything into them. This invention provides a simpler and much more effective solution to the email and message spam dilemma.

The basic premise of this invention is that for any given user or set of users, the number of acceptable email or message sources is far less than the number of undesirable sources and, therefore, it is much easier develop and manage acceptance filters designed specifically for those acceptable sources. So, rather than using lists, algorithms, and rules to reject messages from specific senders or with specific content, this invention uses lists, algorithms and rules to determine if a message is from acceptable source that a user has approved or authorized before the message is imported or viewed. If no acceptance filters are defined, then all messages would be rejected. Furthermore, since the focus of the invention is on managing acceptable sources defined by the user, there is less need to manage filters for undesirable content.

The acceptance filters of this invention are comprised of user-defined email and message acceptance criteria which have multiple methods, ranging from acceptable sources, acceptable domains, rules for accepting messages, algorithms for accepting messages, and Pass Key Codes. The invention also includes an Administrative Function to build and administer the acceptance criteria, provide notification features to aid users in adding new acceptable sources, and to determine what messages are not being delivered. The invention also has an option to perform some system quality control.

Appendix A provides Sample System Activity Reports from the Administrative Function.

FIG. 1 shows the base architecture for the invention with the email and message acceptance logic at the user workstation or email message station, preceding the user's regular email application. Users 100 can setup and manage the filtering methods using the administrative feature 104 of the invention. The administration and filtering take place on the local computer 101. Once acceptance filters are set up email messages are filtered using the filtering system 105 as messages 106 arrive from the originator 103 across the network 102. Filtered email messages are then passed to the user's email system 107 for viewing. Rejected messages are either deleted or placed in the Suspense Hold area 108.

FIG. 2 shows the base architecture for the invention with the email and message acceptance logic at the user workstation or email message station and integrated with the user's email application. With this method, the user must program the acceptance filters into the email application, provided the user's email application allows end-user programming. Users 100 can setup and manage the filtering methods by programming the user's email system 107 with the administrative features 104 of the invention. Once set up, email messages are filtered using the filtering system 105 as messages 106 arrive from the originator 103 across the network 102. The administration, filtering and email management take place in the local computer 101. Rejected messages are either deleted or placed in the Suspense Hold 109 and accepted emails go through the email box 108 to the user 100.

FIG. 3 shows the base architecture for the invention with the email acceptance logic at the email service provide. Users 100 can setup and manage the filtering methods using the administrative feature 104 of the invention. Once set up, email messages are filtered using the filtering system 105 as messages 106 arrive from the originator 103 across the network 102 and passed to the email system 106 for user viewing. The administration, filtering, and email management, take place at the email or message service 107 which is usually a service provider. Rejected messages are either deleted or placed in the Suspense Hold area 108.

FIG. 4 shows the points that the filtering function 104 handles the message before forwarding to the email/message handler 105. The invention sits at the communications/stack point illustrated in this diagram. There are two possible stacks in which the invention is inserted, one at the user email system stack or one at the service provider system stack.

FIG. 5 shows sample table entries for one of the methods of this invention. It shows how security information from user 1 and user 2, both users of the invention, store Pass Key Code information for high security email and message exchange.

### SPECIFICATION BACKGROUND—DESCRIPTION OF PRIOR ART

Prior Art includes patents that address email and message filtering however all prior art uses exclusion methods. This patent application is based on acceptance methods that require filters to indicate acceptable emails or messages. The following patents apply:
1. Method and system for filtering communication—U.S. Pat. No. 7,117,358
2. Method and apparatus for filtering email—U.S. Pat. No. 7,076,5273.
3. Email filtering methods and systems—U.S. Pat. No. 7,072,942
4. Web page filtering including substitution of user-entered email address—U.S. Pat. No. 7,092,992
5. System and method for managing a trusted email datastore—U.S. Pat. No. 7,155,738
6. System and method for a subscription model trusted email database for use in antispam—U.S. Pat. No. 7,181,764
   1. Method and System for Filtering Communication—U.S. Pat. No. 7,117,358

### Abstract

A email relay provides message filtering services to an email network. The email relay monitors incoming communication and intercepts email messages. The email relay compares attributes of the messages to data derived from SPAM messages, which is stored in a SPAM database. The email relay restricts the delivery of message based on the comparison such as by restricting the delivery of messages having attributes close to those of SPAM messages from the SPAM database. The SPAM database is constructed by responding to user or administrator indications as to whether received messages are SPAM messages.

2. Method and Apparatus for Filtering Email—U.S. Pat. No. 7,076,527

### Abstract

A method and apparatus for filtering messages comprising determining a first semantic anchor corresponding to a first group of messages, for example, legitimate messages and a second semantic anchor corresponding to a second group of messages, for example, unsolicited messages. Determining a vector corresponding to an incoming message; comparing the vector corresponding to the incoming message with at least one of the first semantic anchor and the second semantic anchor to obtain a first comparison value and a second comparison value; and filtering the incoming message based on the first comparison value and the second comparison value.

3. Email Filtering Methods and Systems—U.S. Pat. No. 7,072,942

### Abstract

Various embodiments of the invention address two critical problems that current email service providers face. First, there is the problem of maintaining high levels of customer service when email server systems are inundated with spam. Second, there is the problem of reducing the system-wide impact that spam has on the email delivery system. Current embodiments are directed to determining whether an email message is an unwanted bulk email message without necessarily considering the message that is conveyed by any portion of the email message. Through analyses of patterns of delivery of these email messages, profiles are built that allow an email server to ascertain whether there is a likelihood that any one particular email message constitutes an unwanted email message. If an email message is determined to likely constitute an unwanted email message, then memory-saving measures are implemented. In preferred embodiments, one copy of the email message is saved at a central, shared location that can be accessed by each of the intended recipients. This avoids having to replicate the email message across the system for each of the recipients.

4. Web Page Filtering Including Substitution of User-Entered Email Address—U.S. Pat. No. 7,092,992

### Abstract

A method and apparatus for using an intermediary to manage unwanted electronic messages is provided. The intermediary generates a unique address for each pairing of a user and an email resource, such as a mail list. The intermediary maintains a database that identifies which user and which email resource is associated with each unique address. When the intermediary receives messages, the intermediary identifies the user and the email resource based on the database. The intermediary sorts messages for each user based on groups that are associated with each email resource. The intermediary filters the messages to identify messages that are unwanted by the user, such as mass unsolicited email. The intermediary identifies unwanted messages by comparing the sending address for each message to a list of authorized sending addresses for the email resource, and by analyzing the content of the messages, such as identifying whether the messages contain hidden images.

5. System and Method for Managing a Trusted Email Datastore—U.S. Pat. No. 7,155,738

### Abstract

A Trust Email Datastore (TED) system is employed to maintain a list of message addresses with associated trust ratings. The trust rating of a message address is derived from an underlying message address relationship network around the message address of interest through various network related activities such as message sending, forwarding, deleting, blocking, marking as is/is not spam, saving to address book, etc. There may be at least two components of the trust rating between two message addresses. One component of the trust rating, called a relationship trust, may be determined based on proximity of two message addresses in a message address relationship graph. Another component of the trust rating is substantially independent of the positions of two message addresses in the message address relationship graph, and is referred to as a universal trust rating. The trust rating components can be combined and employed for spam filtering.

6. System and Method for a Subscription Model Trusted Email Database for use in Antispam—U.S. Pat. No. 7,181,764

### Abstract

The invention is directed to implementing a trust rating subscription model for email addresses and/or domains in a trust-oriented email network that is supported by a deployment of a trusted email database (TED) system. The TED maintains the trust rating for individual email addresses relative to the recipients. Also, the subscription model enables the email end users and inbox service providers to register with the TED to obtain the trust rating of a specific email sender relative to the recipient. This trust rating may then be used by the email end user or an inbox service provider to filter spam, if the sender is untrusted, or deliver the message to an inbox, if the sender is trusted. A sender (individual email address, domain, and the like) can also subscribe and obtain limited rights to email subscribers of the TED system.

None of the patents above offer the solution presented in this invention and instead use exclusionary methods for filtering email and messages. An exclusionary method accepts ALL emails by default and rejects, or excludes, only those that meet the exclusion criteria set up in the filtering system. The inventors' contention is that exclusionary methods are ineffective and have very high maintenance requirements.

### SPECIFICATION—DETAILED DESCRIPTION

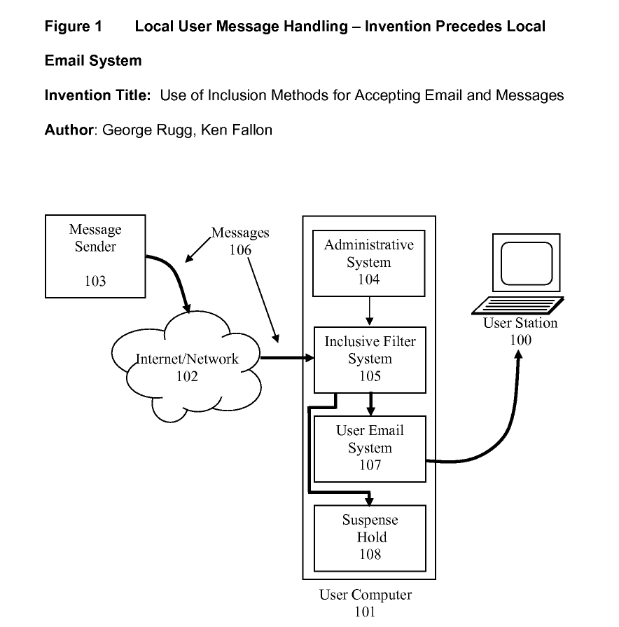

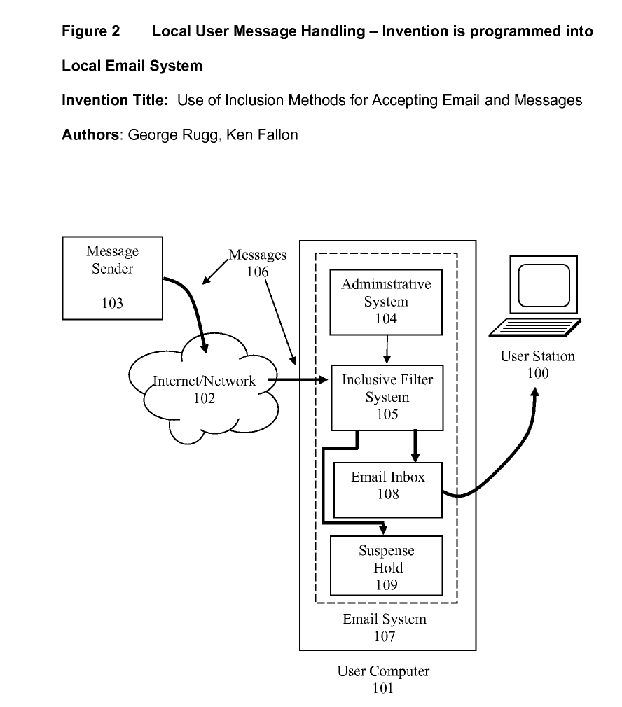

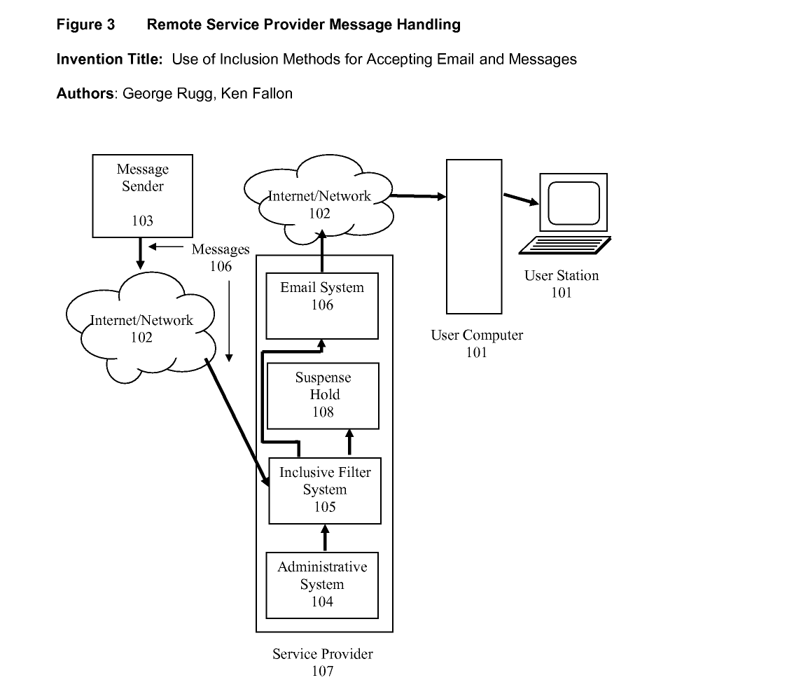

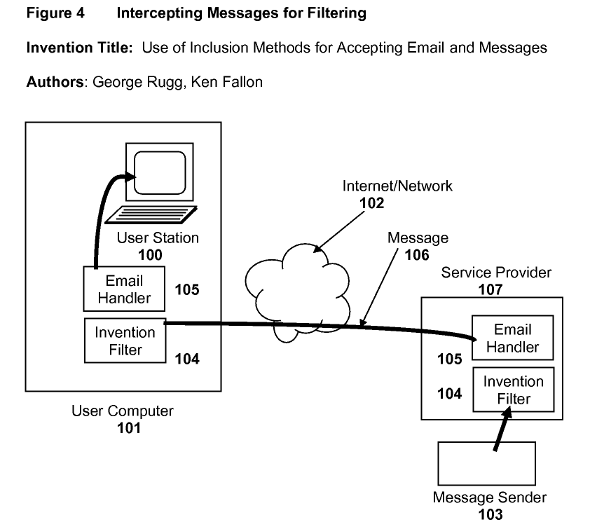

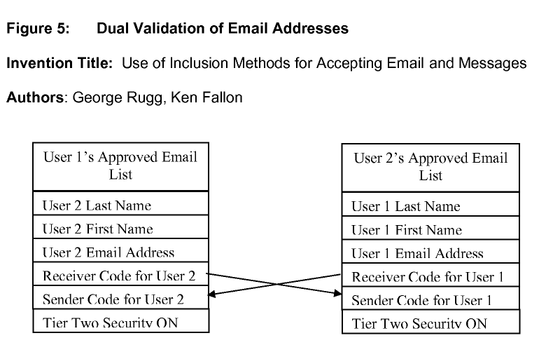

Embodiments of the present invention may be realized in accordance with the following teachings and it should be evident that various modifications and changes may be made in the following teachings without departing from the broader spirit and scope of the invention. The specification and drawings are, accordingly, to be regarded in an illustrative rather than restrictive sense and the invention measured on in terms of the claims. Each method is described in the following sections. In addition to accepting allowable messages, the invention includes a means to administer the inclusion methods. This administration function is comprised of tools to define acceptance criteria, viewing and/or modifying the criteria, assigning criteria to use in the inclusion filter, defining criteria to use for holding messages in a suspense area, collection statistics on email/message acceptance and rejection, notifications on rejected emails/messages, notifications on possible new origin address to add to the included list, and a quality control system to help measure filter effectiveness, spam sources, and email and message security. FIGS. 1, 2, and 3 shows the overall architecture of the invention, FIG. 4 shows the message interception stack locations since it resides where the email/message handler resides and must filter before arrival to that handler, and FIG. 5 illustrates how the invention will store Pass Key Code information from other invention users.

Accepting Emails and Messages by Sender Address:

The invention uses several methods to allow incoming emails or messages to be accepted by the receiver. The Accepting Emails and Messages by Sender Address method is the ability to accept emails or messages based on an approved sender address list. These approved addresses are kept in a user-maintained list that may be in addition to any email or message system address book. Sender addresses of incoming email and messages are compared to entries in the approved sender address list and if there is a match, the email is accepted. The administrative function of this invention allows entry and editing of this list. In addition to storing the email addresses of authorized senders, this list also includes two Pass Key Codes (described in paragraph [0015]) that can be enabled or disabled for added security. Regardless of whether the added security feature is enabled, the invention will generate of a Pass Key Code for each entry in the approved sender list. The second Pass Key Code stored in this list is supplied by the approved sender's system. Use of these data elements in this list is described in paragraphs [0017] and [0026]. User's may define and use more than one approved originator's address list, but the system default list is the one where the Pass Key Codes are stored and it must include the user's address and Pass Key Code. The system default list cannot be removed.

Accepting Emails and Messages by Originator Domain Address:

This method is the ability to accept emails or messages based on an approved domain address. These approved domains are kept in a user-maintained list that is used to compare the incoming domain address and the email is accepted if it is present. This method is especially useful for authorizing messages and emails from known acceptable sources, such as for utility companies or other business entities that the user has frequent communications, but where specific addresses may change from time to time. The administrative function of this invention allows entry and editing of this list.

Accepting Emails and Messages by Using Algorithms:

Various algorithms can be setup to allow additional checking of incoming origin addresses to aid in accepting messages. Below are some algorithms but the inventions is not limited to these; they are presented as an example of the algorithm methods. The administrative function of this invention allows definition of these algorithms so the invention can use them for filtering messages.
An origin address name with embedded wildcards symbols. Theses symbols could include the “*” (allow all characters) or the “$” (allow any character in this position.
Allowable Message Origin Address Prefixes
Allowable message origin address suffix
Allowable identifier field in the origin address

Accepting Emails and Messages by Using Rules:

A rules method is part of the administrative setup allowing additional checking of incoming origin addresses to aid in accepting messages. Below are some rules engine examples but the invention is not limited to these; they are presented as an example of possible rules methods. The administrative function of this invention allows definition of these rules so the invention can use them for filtering messages.
IF {condition} THEN ACCEPT
IF {condition} OR {condition} THEN ACCEPT
IF {condition} AND {condition} THEN ACCEPT
IF {{condition} AND {condition}} OR {condition} THEN ACCEPT
IF NOT {condition} THEN NOT ACCEPT {condition} is a valid test, comparison (equal, not equal, less than, greater than, etc.), calculated evaluation, etc.

Pass Key Code System

There are multiple methods related to Pass Key Codes and the codes are either user-defined or system generated. There are two purposes of the Pass Key Code methods. The first is to help the user add previously unauthorized senders to the approved sender's list without having manually entered them with the administrative function. The second is to add layers of security to the acceptance filters. This invention specifies four principle methods of Pass Key Codes, but is not limited to these methods. The four methods are described here to identify unique functionality of the invention. Four Pass Key Code methods are:

1. Quick Address Acceptance
Single Pass Code Key to allow quick addition to the acceptance list

2. Second Tier Validation of Approved Senders
Matching approved sender with Pass Key Code assigned to sender.

3. Second Tier Pass Key Code with Random Key Code Changing
Second Tier Pass Key Code validation with random key code changes greatly increases the security

4. Closed Access Groups
Second Tier Pass Key Code (use of method 2) for modifying and exchanging Pass Key Codes within a closed email user group.

Quick Address Acceptance

This Pass Key Code method requires that the user generate Pass Key Codes manually using multi-characters to allow for phrases. The purpose of this method is to aid the user in adding previously unauthorized senders to the approved sender list without the receiver having to manually add them. For example, if the system receives an email and the sender is not approved, but the body of the message contains the user's manual Pass Key Code, the system will receive the email and automatically add the sender to the specified approved sender's list. The user need not do anything more than to remember a specific Pass Key Code then disclose that code to a sender with instructions to include it in the body of an email or message. Actions that can be assigned to take place if this Pass Key Code is included in a message include, but are not limited to:
Add sender to the approved sender list
Add sender to the approved list, email receiver Pass Key Code to the sender
Require that the user send a Tier Two code in future correspondence with the sender.
Message contains QC commands (see paragraphs [0025] and [0026])
   Attributes of the manual Pass Key Codes which may be assigned by the user include:
An expiration date for the manual Pass Key Code
A Pass Key Code usage limit (i.e. valid for only x instances, where “x” is a variable)

Second Tier Validation of Approved Senders

With the Second Tier Validation of Approved Senders method, the system utilizes random Pass Key Codes generated by the system. There are two potential codes that can be used; a receiver Pass Key Code and a sender Pass Key Code, both are stored in the approved sender's list as described in paragraph [0011]. Receiver codes are generated locally by the user's system and one is assigned to each approved sender. Sender codes are actually the receiver codes generated by other user's systems which are assigned to the various users. When this tier two security method is enabled, emails or messages from any sender in the approved sender list must now also include the valid receiver Pass Key Code stored in approved sender list. Conversely if a user sends an email to another invention user that has the tier two security feature enabled, the user's message must include a the stored sender code (which is the receiver code the other system generated for the respective approved user). For these levels of security to function without user intervention, other to enable or disable tier two security, the systems must communicate their receiver codes to the respective senders, thereby becoming the sender code for the other system. This information exchange is discussed in paragraph [0026] and illustrated in FIG. 5.

Second Tier Pass Key Code with Random Key Code Changing

The high security system uses the “Second Tier Pass Key Code with Random Key Code Changing” above and adds a random key code changing algorithm. In addition all email exchanges can be encrypted to further secure exchanges. Encryption keys can be the Pass Key Codes themselves. Periodically an instance of the invention can change their valid receiver Pass Code Keys and in a special encrypted message send the new Pass Key Codes to the sender code entries in the sender's approved sender lists. Codes are automatically and randomly changed to reduce the number of potential intrusions if Pass Key Codes are inadvertently acquired by an intruder or hacker.

Closed Access Groups

The closed access group functionality uses the “Second Tier Pass Key Code with Random Key Code Changing” above to create a closed group for email exchanges. In addition all email exchanges can be encrypted to further secure exchanges. Encryption keys can be the Pass Key Codes themselves. Only members of this group can exchange emails and new members must be added using the administrative system to keep the group closed. No one is automatically added. Closed groups are especially useful in high security environments.

Acceptance Administration Function:

The Administrative Feature has several functions. It is used to set up the acceptance lists and criteria and communicate with users to assist in using the invention. The following main functions are described in following sections:
Administrative Setup
Storage and Notification of Rejected Emails
Notification of Unseen Originators
Notification of Rejected Activity Statistics
System (Invention) Quality Control

Administrative Setup:

The Administrative Setup function is a computer program that provides for a means to setup the acceptance lists and criteria to be used when filtering incoming messages. The use of the lists and criteria are described in sections above. The function provides for:
Defining and editing entries in the acceptance email list described in paragraph [0011]. This defines the allowed sender message addresses.
Defining and editing the Domain Address list described in paragraph [0012]. This is a list of all valid Domain addresses that are used to automatically accept incoming messages that are from these domains.
Building the algorithms that are used to test and allow acceptable incoming messages as described in paragraph [0013].
Building the rules that are used to test and allow acceptable incoming messages as described in paragraph [0014].
Building the Pass Key Codes and assign Pass Key Code actions and rules to accept incoming messages as described in paragraph [0016]
Enabling or disabling of higher security Pass Key Code methods and encryption described in paragraphs [0017], [0018] and [0019].
Notifications to users described in following paragraphs [0022], [0023], and [0024].
Enable email and message logging for quality control (QC) purposes.
Configure QC system for reporting.

Storage and Periodic Notification of Rejected/Suspended Emails:

Rejected emails shall be temporarily stored in a suspense file and the administrative function will send a message to the user with a list of rejected emails since the last message of this type was sent by the system. The purpose of this method is to store email messages until the user processes the email message or the system automatically discards the message. The hold message interval is set by an administrative setting. The system generated email address will be the same as the user's which is (which is included in the authorized senders list as described in paragraph [0011]). The system generated email's message content will contain a table listing:
the email addresses of the unknown senders
the originator ID of the unknown sender
the first and last names of the senders (if known)
the date the email was received by the user's email service
the time the email was received by the user's email service.
the subject of the email message
   If the user elects to review a message shown in the table, representing a message in the suspense file, the following options will be available.
1. Receive email. If this item is selected then the email will be forwarded to the user's inbox and the user's email address will be the “new” sender so it will match when compared to the authorized sender list. The email will address will not be added to any of the authorized senders lists described in paragraphs [0011] or [0012]. After review, the user can designate the sender as authorized, unauthorized or make no designation at all. If designated as authorized, then the user must indicate which list(s) (per [0011] or [0012]), to place the sender in. Processed emails in the suspense file will be removed from the suspense file.
2. Receive email—authorized sender: if this item is selected then the email will be sent to the user's inbox as described in [0016], item 1 above, and the sender will be automatically designated as authorized and the pertinent information will be added to the one of the lists (per paragraph [0011] or [0012]), selected by the user. Processed emails in the suspense file will be removed from the suspense file.
3. Unauthorized sender: if this item is selected then the email will be discarded by the system, the sender's email address will be added to an unauthorized senders list, and the email will be discarded from the suspense file.
   If the user decides to not process any of the emails in the suspense file, then all email messages older than a user-defined interval will be permanently discarded.

Notification of New Unseen Originators:

If the “Unseen Notification” option is set the Administrative function sends a message to the user when a new previously unseen origin address and domain address is received. An unseen sender is one that is not any of the authorized sender's lists and not in the unauthorized sender's list. This system message identifies the same information as described in paragraph [0022] and the user has the same message processing options as described in paragraph [0022] items 1, 2, and 3.

Notification of Rejection Activity and Statistics:

The administrative function has an option to send a message to the user containing acceptance statistics and overall system activity. The message interval is set by an administrative setting. This is an informative message to inform users of how well the system is working, activity levels and rejection levels. Reports are also available and sample reports are shown in Appendix A.

System Quality Control:

Another unique characteristic of this invention is the use of a quality control function designed specifically to improve acceptance filter effectiveness and to aid in maintaining system security. The core of the quality control system is based on the use and analysis of log and statistics files (see paragraph [0027] for log and statistics details). Log files will be used to store data for all accepted messages, all rejected messages, all user changes to accepted or rejected emails (i.e. change a sender from authorized to not authorized, or vise versa). In addition log files between senders may be compared to help detect viruses or identity theft.
1. Acceptance Filter Effectiveness: This method of system quality control will help the user determine the effectiveness of their acceptance filters. For example, the user can have the administrative function produce a quality control report that shows the number of times in a user-defined period that accepted emails or messages are later rejected by the user. It will also show which acceptance filter criteria was met in order for the system to accept the message. This is especially helpful to determine any flaws in the algorithm and rules acceptance method logic. This report will also detail the number of system rejected emails and messages that are later accepted by the user. This is helpful in developing new acceptance criteria to reduce the number of false rejections in the future.
2. System Security: The system log files will store information on all message traffic, accepted, rejected, and sent. By comparing, for example, the number of email or messages received from an approved sender to the number sent by that system, it will be useful to detect email identity theft or detect a problem with the one of the systems. In this example both users must configure their systems, using the administrative function, to allow QC message requests. If so configured, QC message requests sent by system A, triggers an internal log file analysis on system B, then system B sends the resulting data back to the requesting system A for comparative analysis. The system that instigated the QC will notify the users that participated in the QC if any log file anomalies are discovered. The QC function is also useful in determining if there have been any abuses of Pass Key Code violations. For example, since the system stores accepted message log files, including which acceptance criteria was met that allowed the system to accept the message, a report showing that a large number of accepted messages were accepted as a result of a Pass Key Code match, then the user should be able to determine the likely source that released or disclosed the Pass Key Code.

Inter-System Information Exchange:

The Administrative function has the ability to communicate with other systems that have the invention installed. The communication exchange uses a specially encoded email or message that is detected by the receiving system and contains commands. The receiving system executes the command and returns the requested information or data. Following is a list of commands with responses but the invention is not limited to this list:
Send the specified email acceptance list
Update sender Pass Key Codes
Add the attached list to the system's acceptance list
Add the identified addresses to the acceptance list
Remove the identified addresses to the acceptance list
Return any emails received from the specified address
Return the specified set of collected statistics
Return current system firmware version
Update system firmware

The invention allows a configuration option to prevent incoming management commands or to only accept incoming commands from a particular email or origin address. In addition the invention can be configured to allow a certain “Pass Key Code” to indicate an incoming command.

Log and Statistical Collection:

The invention writes a log file that contains certain information on every incoming email or message. In addition the invention periodically collects and writes statistical information to a statistics file. Both log and statistics files are used to capture management information about message exchanges. This information can be displayed in reports and optionally collected from other systems that are using the invention and are configured to accept incoming requests. Following is a list of log and statistics entries but the invention is not limited to these:

Log entries:
Origin Address
Time Stamp
Message Subject
Action taken
Algorithm or Rule Identifier
Other email or message properties
   Statistical entries for a single recording:
Number of emails per ID
Number of attachments
Rate of reception
Average message size
Largest message size
Smallest message size
Average attachment size
Largest attachment size
Smallest attachment size
Number of messages in the accepted file
Number of messages in the suspense file
Number of messages in the not accepted file.
Number of messages held in the suspense file, then rejected.
Number of messages held in the suspense file, then accepted

What is claimed is:

1. The invention will allow email and message reception using acceptance methods whereas;
the invention, by default, will reject all email and messages unless the messages pass acceptance criteria filtering methods to include;
the email and message addresses contained in an authorized senders list and;
the domain addresses contained in an authorized domain name list and;
algorithms may be written and designated as acceptance criteria to authorize acceptance of emails and;
rules may be written and designated as acceptance criteria to authorize acceptance of emails whereas;
using methods claimed above, the invention can automatically add users to an authorized senders list.

2. The invention also provides Pass Key Codes where character sequences in messages or emails can be defined and/or enabled and designated as acceptance criteria for previously unauthorized senders, and to improve security whereas;
the invention can disable Pass Key Codes after predetermined intervals and;
the invention can disable Pass Key Codes after a predetermined number of uses and;
the invention can require that certain authorized users also use a specific Pass Key Code and;
systems may be set to require inclusion of valid Pass Key Codes to accept any email message and;
for high security enable automatic updates of randomly generated Pass Key Codes that are exchanged between users of the invention whereas;
using methods claimed above, users may have Pass Key Codes update at regular intervals.

3. The invention is compatible with email and message systems where:
The invention is complimentary and compatible with existing email systems installed on local workstations and;
the invention is compatible with existing internet-based email systems whereas;
the methods described above may be programmed into existing email applications that allow end-user programming and;
the invention may sit ahead of the email/message handler on the protocol stack to provide the filtering and the invention may reside on the user's computer or at a service provider center where the accepted email/message is forwarded to the user's email/message handler.

4. The invention provides an Administrative Function that sets up and maintains the lists and criteria for accepting email/messages, informs users of new unseen messages, periodically send a list of rejected emails for review by the user, and includes a quality control function whereas:
as a component, the quality control function can produce quality control reports to assist the user in measuring acceptance filter effectiveness and;
as a component, the quality control function can help to determine potential system security violations and;
as a component, the invention can issue commands through email or messages to other systems using the invention and exchange management information, control a network of the inventions and produce reports and;
the invention collects detailed log and statistical data to aid in management and control of the system.
